(19) United States
(12) Patent Application Publication
(10) Pub. No.: US 2023/0122469 A1
(43) Pub. Date: Apr. 20, 2023

(54) X-RAY DIFFRACTION AND IMAGING SOFTWARE AND COMPUTER-IMPLEMENTED SYSTEMS

(71) Applicant: Regents of the University of Minnesota, Minneapolis, MN (US)

(72) Inventors: Guichuan Yu, Woodbury, MN (US); Javier Garcia Barriocanal, St Paul, MN (US)

(21) Appl. No.: 18/046,885

(22) Filed: Oct. 14, 2022

Related U.S. Application Data
(60) Provisional application No. 63/256,178, filed on Oct. 15, 2021.

(51) Int. Cl. G06T 15/00; G06T 7/00; G06T 7/20; G06T 7/70; G06V 10/25; G06V 10/44

(52) U.S. Cl. CPC G06T 15/00; G06T 7/0012; G06T 7/20; G06T 7/70; G06V 10/25; G06V 10/44; G06V 2201/07; G06T 2207/10116

(57) ABSTRACT

A system and method for converting 2D x-ray images into a 3-dimensional reciprocal space image. Each x-ray image in the plurality of x-ray images is a 2-dimensional image corresponding to a different location of a 2-dimensional x-ray detector relative to an x-ray beam that intersects a sample. The system determines, based on the x-ray images, the orientation of the sample and converts the x-ray images into a 3-dimensional reciprocal space image based on the x-ray images and on the sample orientation.

This application claims the benefit of U.S. Provisional Patent Application 63/256,178, filed Oct. 15, 2021, the entire content of which is incorporated by reference.

### BACKGROUND

A traditional process for x-ray diffraction utilizes an x-ray diffraction (XRD) apparatus (also known as an x-ray diffractometer) that includes an x-ray source, a sample, and a 0-dimensional (OD) x-ray detector. The x-ray source emits an x-ray beam. The sample and OD x-ray detector may be positioned and rotated relative to the x-ray beam in various ways. The XRD apparatus measures the intensity of the scattered x-ray beam from the sample at various sample angles and detector positions. In most cases, XRD focuses on sharp, intense scattering peaked at certain locations called Bragg peaks. The positions and relative intensities of the Braggs peaks contain the information to extract the atomic structure of the sample. In such traditional processes, a computing system of the XRD apparatus calculates the sample angle and detector position where a Bragg peak is expected.

The XRD apparatus then moves the sample relative to the x-ray detector positions in many fine steps around the sample angle and detector position where a Bragg peak is expected to determine the precise location, intensity, and shape of the Bragg peak. In one measurement, the XRD apparatus repeats this process for many Bragg peaks. This traditional process involves repositioning the sample relative to the x-ray detector many times for each Bragg peak. Repositioning the sample and x-ray detector in this way is very time consuming for one measurement. During the last two decades, thanks to the development of photon detecting technologies, 1D and 2D detectors have replaced the OD detector in x-ray diffractometers, increasing the speed of data acquisition.

### SUMMARY

This disclosure describes analytical techniques for x-ray diffraction. A goal of x-ray diffraction is to determine the positions of atoms in a sample. The techniques of this disclosure may accelerate the process of analyzing the results of x-ray diffraction.

In one example, a system comprises a memory configured to store a plurality of x-ray images captured by a 2-dimensional x-ray detector, each x-ray image in the plurality of x-ray images being a 2-dimensional image corresponding to a different location of the 2-dimensional x-ray detector relative to an x-ray beam that intersects a sample; and processing circuitry coupled to the memory, the processing circuitry configured to determine, based on the x-ray images, orientation of the sample; and convert the x-ray images into a 3-dimensional reciprocal space image based on the sample orientation.

In another example, a method includes determining, based on x-ray images from a 2-dimensional x-ray detector, orientation of a sample, each x-ray image in the plurality of x-ray images being a 2-dimensional image corresponding to a different location of the 2-dimensional x-ray detector relative to an x-ray beam that intersects the sample; and converting the x-ray images into a 3-dimensional reciprocal space image based on the x-ray images and the sample orientation.

In yet another example, a computer readable medium includes instructions that, when executed by a processing system, determine, based on x-ray images from a 2-dimensional x-ray detector, orientation of a sample, each x-ray image in the plurality of x-ray images being a 2-dimensional image corresponding to a different location of the 2-dimensional x-ray detector relative to an x-ray beam that intersects the sample; and convert the x-ray images into a 3-dimensional reciprocal space image based on the x-ray images and the sample orientation.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a block diagram illustrating an example x-ray diffraction system, in accordance with one or more techniques of this disclosure.

FIG. 2 is an illustration of a method for converting 2D x-ray images obtained from x-ray diffraction into a 3-dimensional scattering intensity map in reciprocal space, in accordance with one or more techniques of this disclosure.

FIG. 3 is an illustration of a 3-dimensional scattering intensity map in reciprocal space, in accordance with one or more techniques of this disclosure.

FIG. 4 is an illustration showing a different aspect of the 3-dimensional scattering intensity map in reciprocal space from FIG. 3, in accordance with one or more techniques of this disclosure.

FIG. 5 is a block diagram illustrating an example of the x-ray diffraction system of FIG. 1, in accordance with one or more techniques of this disclosure.

FIG. 6 is an illustration showing movement in reciprocal space corresponding to movement of a detector in real space, in accordance with one or more techniques of this disclosure.

FIG. 7 illustrates how the raw data may be rasterized on a 3D grid in reciprocal space, in accordance with one or more techniques of this disclosure.

FIG. 8 is an illustration showing a method of directly extracting scans from 2D x-ray images, in accordance with one or more techniques of this disclosure.

FIG. 9 is an illustration showing a method of simulating slits when directly extracting scans from 2D x-ray images, in accordance with one or more techniques of this disclosure.

FIG. 10 is an illustration showing a method of extracting momentum scans in reciprocal space, in accordance with one or more techniques of this disclosure.

Like reference characters refer to like elements throughout the figures and description.

### DETAILED DESCRIPTION

As noted above, 1D and 2D detectors have replace the OD detector in x-ray diffractometers, increasing the speed of data acquisition when searching for a Bragg peak. This disclosure describes techniques that may further accelerate the process of x-ray diffraction by incorporating image analysis and image processing on x-ray diffractometers equipped with an area (2-dimensional (2D)) x-ray detector. As described herein, an x-ray diffraction system may include a 2D x-ray detector. Also as described herein, a 2D x-ray diffractometer does include an a 2D x-ray detector. Each 2D x-ray detector generates a 2-dimensional-grid of intensity values in the form of a 2D image for a given detector position.

This technique involves a computing system that processes a series of 2D x-ray images generated by a 2D x-ray diffractometer from a sample under test. In one example approach, the 2D x-ray detector may determine the orientation of the sample from the series of 2D x-ray images and then converts the x-ray images into a 3-dimensional scattering intensity map in reciprocal space based on the sample orientation. In one such example approach, the computing system determines sample orientation by identifying locations and peak profiles of one or more Bragg peaks in the 2D x-ray images.

The 3-dimensional scattering intensity maps may be used for structural analysis and visualization of the sample. Because the computing system digitally extracts detail information of the Bragg peaks from multiple 2D images through computational image processing techniques, the computing system may require less time-consuming repositioning of the x-ray detector and sample on the XRD apparatus.

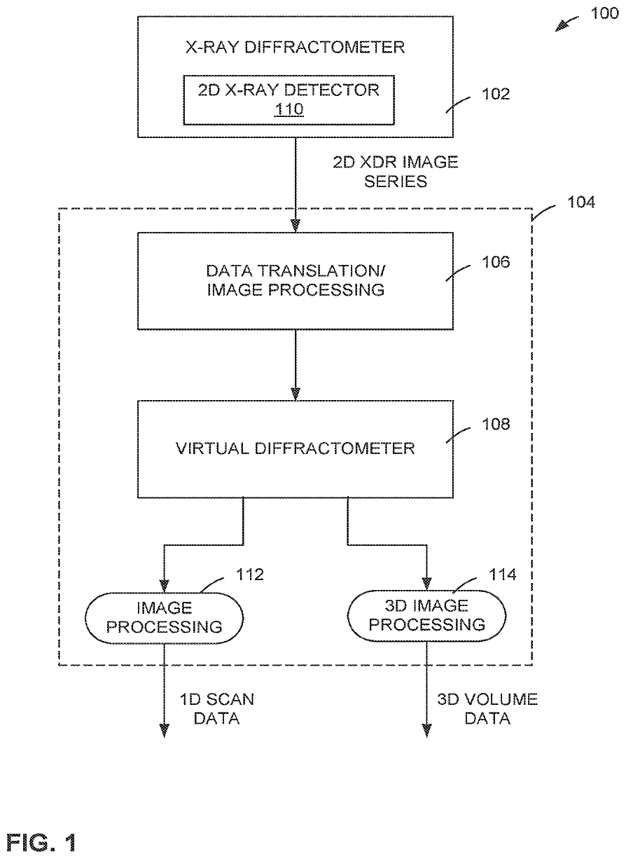

FIG. 1 is a block diagram illustrating an example x-ray diffraction system, in accordance with one or more techniques of this disclosure. As noted above, X-ray diffraction is a major characterization technique to study material structure at atomic resolution. In the example approach illustrated in FIG. 1, an XRD analysis system 104 is connected an XRD apparatus 102 having a 2D x-ray detector 110. In the example in FIG. 1, XRD apparatus 102 analyzes a sample to obtain a series of 2D x-ray images representing diffraction of x-rays off the sample at different positions of detector 110. Each 2D x-ray image includes intensity values resulting from diffraction off the sample for a given position of the 2D x-ray detector 110. In the example shown in FIG. 1, XRD analysis system 104 includes a data translation/image processing system 106 and a virtual XRD system 108 (or virtual diffractometer 108). XRD analysis system 104 receives the series of 2D x-ray images from XRD apparatus 102. Data translation/image processor 106 of XRD analysis system 104 performs any data translation or image processing needed to standardize the series of 2D x-ray images before presenting the series of 2D x-ray images to virtual diffractometer 108. Virtual diffractometer 108 converts the input 2D x-ray images (received from processing system 106) to the output 3D reciprocal space images.

In one example approach, virtual diffractometer 108 includes a collection of functions (mathematical or numerical computation) used to perform the conversion from 2D x-ray images to 3D reciprocal space. In one example approach, the precise orientation of the sample being tested must be known in order to perform such a conversion and in order to combine the multiple images from the series of 2D x-ray images correctly, because the mathematical function of the conversion depends on knowing the exact sample orientation and on knowing the sample crystal structure.

In cases where the sample orientation is not known, it may be determined from the 2D x-ray images as detailed below. In the discussion below techniques will be presented for automatic and interactive ways of determining sample orientation. In one example approach, software in either processing system 106 or virtual XRD system 108 determines the exact sample orientation from the received series of 2D x-ray images. In one such example approach, this involves automatically determining the (multiple) peak locations in (multiple) images, then using those peak positions to calculate the exact sample orientation. In another such example approach, this involves interactively determining the (multiple) peak locations in (multiple) images, then using those peak positions to calculate the exact sample orientation. Virtual XRD system 108 then performs the conversion. Such an approach greatly simplifies XRD experiments.

The system of FIG. 1 introduces full 3D imaging capability in XRD software, combining sophisticated imaging analysis and processing with traditional X-ray diffraction analysis, and enabling automatically or semi-automatically analysis on large sets of X-ray image data in a holistic approach.

The XRD software of XRD analysis system 104 increases the efficiency in conducting X-ray diffraction (XRD) experiments using existing X-ray diffractometers 102 equipped with 2D x-ray detectors 110. This may be achieved by systematically collecting multiple series of images at various angles of detector 110 on each diffractometer. System 104 combines information from a large number of images, then extracts desired scans and maps of scattering intensities via digital processing. In contrast, traditional methods align the instruments on individual Bragg peaks and perform physical scans through the peaks point-by-point. The latter results in low efficiency to employ 2D detectors when multiple Bragg peaks need to be measured. For example, the method described herein obtains the same reciprocal space mapping (i.e., map of scattering intensities in the reciprocal space) much more quickly. In some cases, the method may be orders of magnitude quicker (i.e., >100 times) compared to traditional point-by-point scans.

In one example approach, the XRD software of XRD analysis system 104 is designed to be universal software. That is, the XRD software is designed to extend the capabilities of any commercial laboratory diffractometer (such as the instruments at university characterization facilities and the companies) and any custom-built X-ray diffractometers (such as the instruments at the national synchrotron laboratories and custom-built instruments at university research laboratories) with 2D x-ray detectors 110 without any hardware modifications. Therefore, it may be used to enhance the existing diffractometers without paying for the cost of hardware modification and upgrade.

XRD analysis system 104 introduces complex imaging analysis (automatic or semi-automatic analysis via machine-learning and/or specially designed algorithms for X-ray data) into X-ray diffraction data analysis. XRD analysis system 104 seamlessly combines analysis within individual images and among a sequence of images to automatically identify information about Bragg peaks and other features, then uses the information to process the diffraction data (more details in the technique sections). This drastically reduces the effort in processing large amount of imaging data (a single experiment contains many series of images, with each series containing hundreds of images), making it easy for the researchers to extract information and focus on resolving materials structure, avoid distraction from laborious data processing.

XRD analysis system 104 seamlessly integrates one dimensional (1D), two-dimensional (2D) and three-dimensional (3D) data visualization and analysis into a single package. For instance, XRD analysis system 104 introduces methods to combine multiple 2D detector images into 3D volume data in reciprocal space (forming a 3D reciprocal space map) for 3D visualization, a technique termed 3D reciprocal space imaging. In one example approach, XRD analysis system 104 introduces methods to extract, via 3D image processing 114 of FIG. 1, various representations of the 3D volume data for display in a representation of 3D reciprocal space. The 3D volume data may, for instance, be displayed as a 3D reciprocal space map of intensities.

XRD analysis system 104 also introduces methods to extract, via image processing 112 of FIG. 1, various kinds of 1D scan data directly from 2D detector images or from the 3D reciprocal space maps. This allows XRD analysis system 104 to digitally emulate physical measurements on the instruments (point-by-point scans) after the experiments are done. In some cases, such “digital measurements” are significantly more efficient than physical measurements; in some cases, this post experiment data processing capability allows the researchers to fully explore their existing data, extracting additional information without redoing the physical experiments.

XRD analysis system 104 simplifies the procedure and reduces the expertise requirement for researchers conducting X-ray experiments. In a traditional point-by-point scan approach, X-ray diffractometer software needs to know the precise orientation of the sample (sample alignment) in order to scan across the Bragg peaks. This physical sample alignment on the instruments involves multiple scan steps, a complicated procedure for untrained researchers, creating an expertise barrier for conducting X-ray experiment. In XRD analysis system 104, the determination of the sample's alignment is performed digitally rather than physically, greatly simplifying the experiments. In one such example approach, experimenters pick several Bragg peaks from the images, the software analyzes the peak information using imaging analysis, automatically calculating the orientation of the sample. In addition, although traditional measurements require a sample to be precisely aligned during the experiments, in the XRD analysis system 104 the orientation of the sample only needs to be roughly known during the experiments. Precise alignment and extraction of the orientation from the experimental results can be done in software after the experiments. This simplifies the experimental procedure.

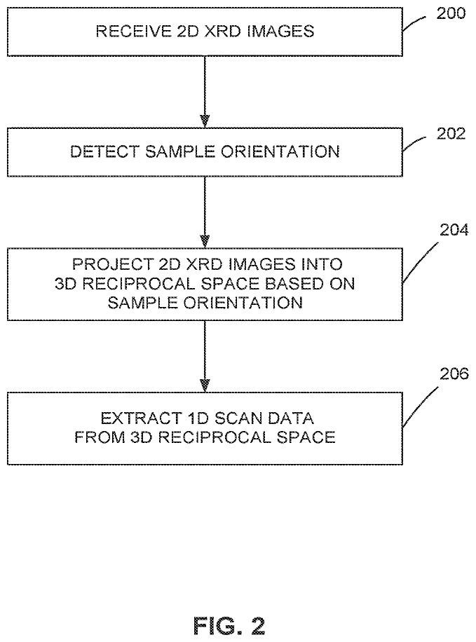

FIG. 2 is an illustration of a method for converting 2D x-ray images obtained from x-ray diffraction into a 3-dimensional scattering intensity map in reciprocal space, in accordance with one or more techniques of this disclosure. In the example method of FIG. 2, a series of 2D XRD intensity images are received at XRD analysis system 104 from an XRD apparatus 102 (200). The images are analyzed to determine the orientation of the sample (202). XRD analysis system 104 then projects the 2D XRD images into 3D reciprocal space based the intensity values of the XRD images and the sample orientation. In one example approach, XRD analysis system 104 extracts various kinds of 1D scan data directly from the 2D XRD images or from the 3D reciprocal space maps via image processing 112 as shown in FIG. 1 and as further detailed below.

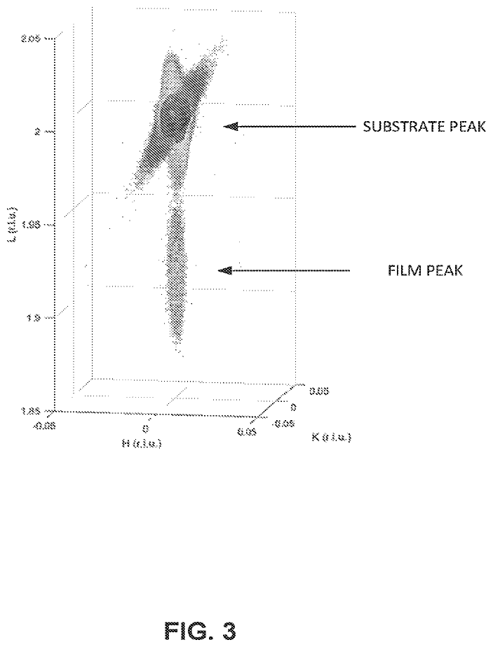

FIG. 3 is an illustration of a 3-dimensional scattering intensity map in reciprocal space, in accordance with one or more techniques of this disclosure. In the example shown in FIG. 3, the structure on top represents a mapping of the intensities of the substrate peak, while the structure on the bottom represents a mapping of intensities for the film peak.

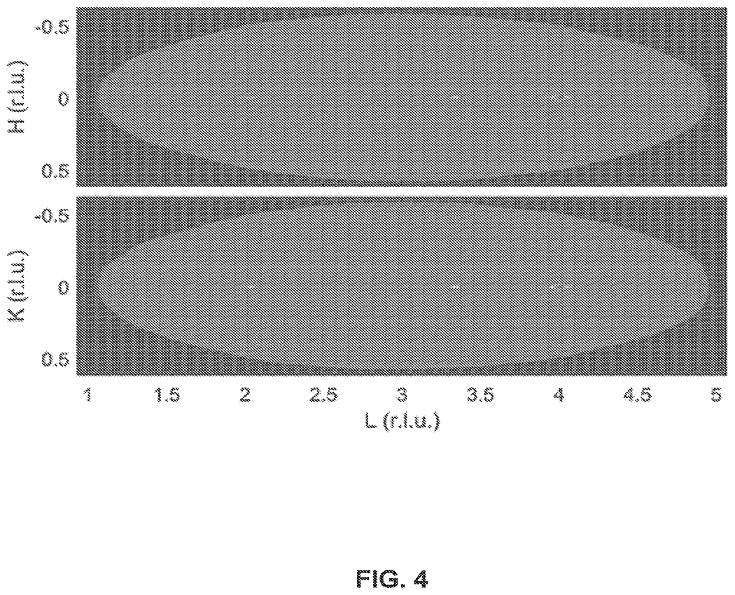

FIG. 4 is an illustration showing a different aspect of the 3-dimensional scattering intensity map in reciprocal space from FIG. 3, in accordance with one or more techniques of this disclosure.

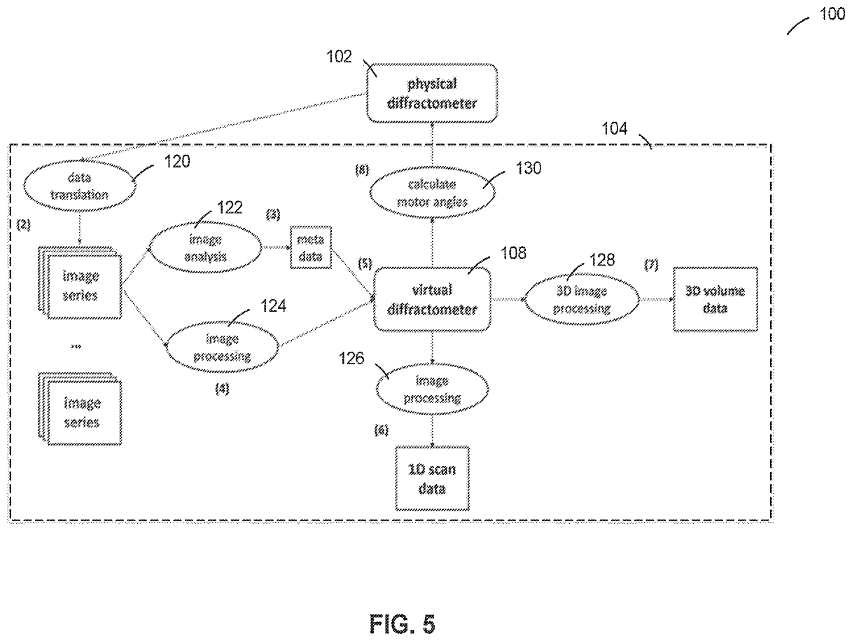

FIG. 5 is a block diagram illustrating an example of the x-ray diffraction system of FIG. 1, in accordance with one or more techniques of this disclosure. In general, X-ray instrument software is designed by the instrument vendors to run on their specific hardware, not on instruments from different vendors. XRD analysis system 104 introduces support for wide ranges of hardware to unleash their potential capabilities via a highly customizable modular diffractometer software module (referred as a virtual diffractometer 108 in FIG. 5, as opposed to the physical instruments 102 shown in FIG. 5. This may be achieved by first mapping the physical instrument (XRD apparatus 102) to the virtual instrument (virtual XRD system 104).

In one example approach, virtual diffractometer 108 includes swappable software components, including an x-ray source, sample, motor, and detector object, similar to a physical instrument. Each component provides common functional interfaces (for example, the mapping between the diffractometer motor angles and the coordinates in the reciprocal space) for the XRD analysis system 104 to operate for all instruments, while the calculations specific for individual instruments (such as the motor angles) may be implemented transparently, i.e., the implementations of those functions are hidden from the XRD analysis system 104 main program and are dealt with by different types of instruments case by case. The base objects may support the generic diffractometer setup such as typical four-circle diffractometer. Other instruments may be mapped onto this generic diffractometer by changing parameters in the software components. More sophisticated instruments such as six-circle diffractometers and custom-built instruments may be mapped to class objects derived from the base objects. XRD analysis system 104 may switch between different virtual diffractometer setups from the graphic user interfaces, to configure and perform calculations for different kinds of instruments.

XRD analysis system 104 includes data translation software 120 used to handle the different data formats from different instruments 102. In one example approach, XRD analysis system 104 includes data loading modules used to convert the input imaging data received from the physical instruments 102 (Step 1 of FIG. 5) into a standard format (Step 2 of FIG. 5) designed for the image series analysis. For each experiment, the translated data may include multiple virtual folders, with each folder containing a sequence of image files (the virtual folders and files are not necessarily stored as physical folders and files in the computer storage). Each virtual folder corresponds to a single scan on the physical instrument, i.e., a series of images taken at each step when the diffractometer drives one or a combination of more than one motors from the starting points (angles) to the end points in linear steps. In one such example approach, the image files contain the individual images and the metadata of those images (including the motor positions and other information of the diffractometer when the images were taken). This processing enables XRD analysis system 104 to handle different instruments in a consistent manner, and to prepare the data for the complex imaging analysis below.

In one example approach, XRD analysis system 104 integrates complex imaging analysis into the X-ray diffraction data analysis. Traditional XRD imaging analysis is very basic. It typically only performs integration of the image data in the region of interest (typically small rectangular regions in an image that contain the peaks) and performs basic background subtraction (e.g., to remove the background below the peaks within the region of interest). Commercial instrument XRD software typically lacks the capability to process information from big data (thousands of images from a single experiment) in a holistic approach.

XRD analysis system 104 integrates both sophisticated image analysis and sophisticated image processing, to automatically or semi-automatically process large amounts of image data, reducing the data into information essential for the materials structure modeling.

In XRD analysis system 104, image analysis uses a custom-designed algorithm (e.g., a non-machine-learning pipeline or a machine-learning based algorithm) to perform automatic identification of peaks and features, extracting the peak properties including their positions and widths. This analysis is carried out both within a single image, and across a series of consecutive images in a scan to generate additional metadata (i.e., new information) (Step 3 in FIG. 5) for subsequent data processing.

The intensive imaging analysis introduced in XRD analysis system 104 into XRD data analysis may be implemented in the following data processing:
(a) Automatically identify peak maximum positions in the images. The virtual diffractometer combines the metadata in the input images with the analyzed position data to automatically determine the precise sample orientation. This greatly simplifies experimental procedure (1) for sample alignment (the most difficult step for non-expert), and (2) allows the precise sample alignment after the experiments for the digital extraction of scans.
(b) Automatically identify features above uninteresting background (the background can be very complicated). Image processing 124 in (Step 4 of FIG. 5) uses the information to perform full image background subtraction. This is different from the traditional basic XRD analysis, where the background subtraction is only done in a narrow region near peaks and is much simpler. When step (4) is not necessary, it may be bypassed.
(c) Automatically track the positions of the peaks and broad features in a series of images (a scan) and use the information to extract a traditional scan (emulate a physical scan digitally, e.g., as described in greater detail elsewhere in this disclosure) (Step 6 of FIG. 5).
(d) In 3D data construction, one or multiple series of images are converted into reciprocal space (Step 5 in FIG. 5) and then assembled into 3D maps. In one example approach, image analysis 122 identifies the images not containing any features (e.g., images that only contain background) and discards them, in order to (1) reduce the background and produce higher quality 3D and 2D maps, and (2) reduce computation to speed up the 3D processing.
(e) To make 3D data processing, visualization, and management practical on a normal PC (e.g., a desktop or workstation), the feature location information from image analysis 122 is used to decide which 3D regions contain non-trivial data, therefore reducing the processing and storage requirements for 3D visualization.
(f) For the diffractometer software to convert the detector images into the reciprocal space precisely, the precise detector to sample distance must be known. XRD analysis system 104 simplifies the calibration of the precise detector-sample distance. In one example approach, calibration is done by performing a x-angle scan of a Bragg peak on the diffractometers 102. The imaging analysis tracks the positions of the peak maximum in a series of images, and the virtual diffractometer 108 uses those positions to automatically fit the distance.
(g) Sometimes, it is important to understand the parasite phases in the materials of interest. Those secondary phases normally generate rings (the powder rings) in the images due to the amorphous structure. The imaging analysis combined with the virtual diffractometer calculation can automatically extract the 20-scan from the images (the 20-scan in powder diffraction is the standard procedure to evaluate phases in materials).

3D reciprocal space map construction, processing, and visualization in XRD analysis system 104 will be discussed next. XRD analysis system 104 drastically increases the efficiency of any supported lab instruments 102 through its capability to construct 3D reciprocal space mapping efficiently without redundant measurements. In traditional instrument software, information from 2D detectors is under-utilized. Multiple scans may cover regions partially overlapping in reciprocal space, making part of the information repeating, reducing the overall efficiency. In addition, traditional measurement requires precise alignment at Bragg peak centers before an actual scan taken place, wasting significant instrument time to perform such a procedure (multiple alignment scans need to be done and the peak center is fitted before the actual scans to take useful data). (Step 2) XRD analysis system 104 extracts all the information needed for the structural analysis (traditional scans) from the 2D or 3D data digitally. Therefore, it does not require precise alignment during the measurement. The alignment is done automatically in software when extracting scans during the data analysis.

In explanation, the detector image is collected in real space, in which the information cannot be directly used to resolve materials structure. The diffractometer software of XRD analysis system 104 converts the real space positions into reciprocal space, in which the collected intensity data represent the Fourier transformation of the materials atomic structure. Obtaining the 1D scans (1D intensity data) and 2D maps (2D intensity data) in reciprocal space is the starting point for modeling the materials structures in XRD analysis system 104.

XRD analysis system 104 introduces 3D reciprocal space map construction and visualization on supported instruments 102, with the focus on adding such capability to existing commercial lab instruments 102. The commercial lab instrument software typically includes only basic 1D or 2D data analysis and visualization (no 3D capability), and only performs analysis in reciprocal space in 1D. (Custom-built instrument at national synchrotron laboratories may offer experimental utilities for 3D XRD data visualization, but still lack 3D reciprocal space mapping capability in their instrument software).

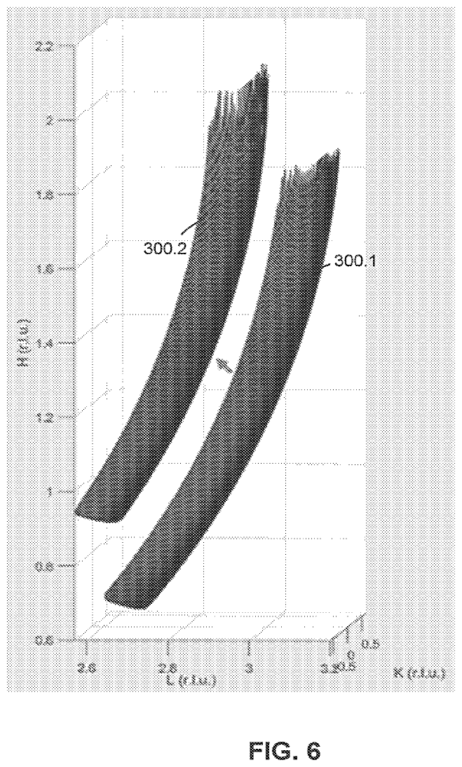

FIG. 6 is an illustration showing movement in reciprocal space corresponding to movement of a detector in real space, in accordance with one or more techniques of this disclosure. In one example approach, XRD analysis system 104 constructs 3D volume data in reciprocal space (via 3D reciprocal space maps). One function of the XRD analysis system 104 is to process large numbers of detector images and combine them into 3D maps in reciprocal space for visualization and analysis. A single detector image occupies a 2D curved surface area in the reciprocal space (FIG. 6, position in reciprocal space is denoted by coordinate, (H, K, L), corresponding to the Fourier components of real space (X, Y, Z)). When the instrument 102 moves detector 110 one or a combination of several motor angles, the surface area in the reciprocal space moves from one position to another (indicated by the arrow), enclosing a 3D volume in between. XRD analysis system 104 utilizes this fact to measure all data points within the enclosed 3D volume and to construct 3D maps very efficiently (since the detector 110 only needs to move along a one-dimensional trajectory to obtain 3D volume data).

A method of analyzing a sample will be discussed next. In one example approach, an instrument 102 are driven to the starting positions (angles) of the reciprocal space region to be studied (surface 300.1 at the start of the arrow). Then the instrument moves one or a combination of several motor angles in small linear steps to the end position (surface 300.22 at the end of the arrow). At each step, the detector 110 records the image (scattering intensities). The many images (surfaces 300) between surfaces 300.1 and 300.2 cover the 3D volume of interest.

In some example approaches, there are no restrictions in how to drive the instrument angles during the “sweep” (sweep 2D surface in space to create 3D volume). Typically, however, it is better to choose the simplest way to perform the sweep (i.e., only move the w-angle (one of the sample rotations) in the scan). Since such a move only covers very limited 3D volume, one may perform multiple such kind of scans centered at different reciprocal space locations. When combined, the scans form a large 3D volume (see, for example, FIGS. 3 and 4, which shown the capability of XRD analysis system 104 to generate a very-wide-range reciprocal space map).

In one example approach, XRD analysis system 104 provides calculations about (1) where (what diffractometer angles) to do such kinds of scans, (2) the step size of the scans according to user required 3D-map resolution, and (3) the range of each scan to avoid gaps in 3D reciprocal space when combining multiple scans to form a large 3D volume.

In one example approach, three-dimensional data processing is performed by virtual diffractometer 108. In one such example approach, virtual diffractometer 108 first converts every detector image (intensity value at each pixel) into an array of reciprocal space coordinates and the corresponding intensity value (H, K, L, intensity). Data in multiple images are concatenated into a large array, which contains all the information from those images. This is referred to as the 3D raw (reciprocal space) data.

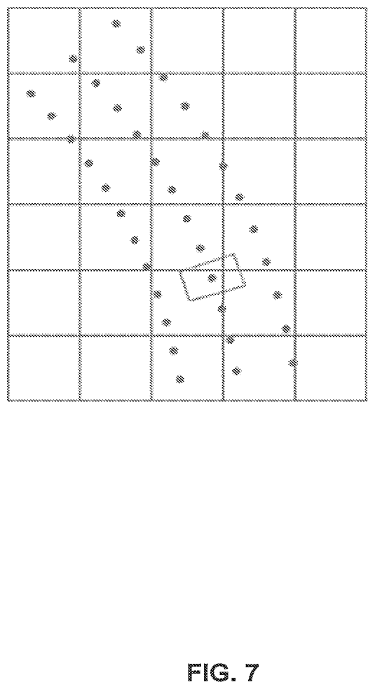

The second step is to grid the data in reciprocal space. FIG. 7 illustrates how the raw data may be rasterized on a 3D grid in reciprocal space, in accordance with one or more techniques of this disclosure. To create a 3D visualization, the raw data may be rasterized on a 3D grid in reciprocal space (the raw data does not fall on the grid as they follow curved surfaces in reciprocal space, illustrated in FIG. 7. The points indicate the data points in 3D; the square lattice represented where the rasterized 3D data points should be. In one example approach, XRD analysis system 104 employs three different methods for the rasterization process in different parts of the software: data binning (low computational cost), interpolation (medium computational cost) and intensity re-distribution (high computational cost).

In data binning, data points are binned to the nearest bins (illustrated as squares in FIG. 7). In each square, the total intensities are added together to obtain the rasterized intensity map. Such a procedure may, however, introduce artifacts in the resulted maps due to the rounding of the point positions. Therefore, this method requires the calculation of the size of the bins to match (lower or equal) the spatial resolution of the original data. In interpolation, at each grid position, the intensity value is interpolated from the 3D raw data. Such a procedure is used for 3D visualizations of the data, such as for 3D contour plots as shown in FIG. 3.

In intensity re-distribution, each data point occupies an area (illustrated as the diagonally slanted box in FIG. 7). This method calculates the intersection of this area with the nearby squares. The intensity value at each square includes the sum of the weighted intensities of all the nearby points. The weighted intensity is the intensity of a point multiplied by the fraction of area (to the total area of that point, i.e., the area of the diagonally slanted box) that falls into the square.

Extraction of 1D scans from 2D and 3D data sets will be discussed next. In one example approach, XRD analysis system 104 primarily relies on computational extraction (from the 2D images or the 3D maps) of all kinds of scans that traditional are physically performed on the instruments 102. That is typically how other diffractometer software works. The approach taken in XRD analysis system 104 greatly simplifies the experiments and makes precise alignment on each measured peak unnecessary. As a result, it improves the efficiency to utilize the instruments 102, and offers flexibility to extract (full) information from the experimental data in post experiment data processing.

In one example approach, XRD analysis system 104 includes two types of software scan emulation: directly extract scans from the input 2D images and extract 1D scans from the constructed 3D reciprocal space maps (i.e., slice 1D data from 3D images). Direct extraction from the 2D x-ray images will be discussed first.

In one example approach, XRD analysis system 104 supports direct extraction of scans from the input 2D images to emulate the physical scans of the instruments in the angle space, such as omega scan and 2-theta scan. In some such example approaches, when a wide reciprocal space is covered by the measurement, XRD analysis system 104 enables extraction of 2-theta scan for a large number of Bragg peaks, allowing structural analysis for powder diffraction (phase analysis and structure refinement) directly applied to structural analysis for single crystals and for composite structures like films.

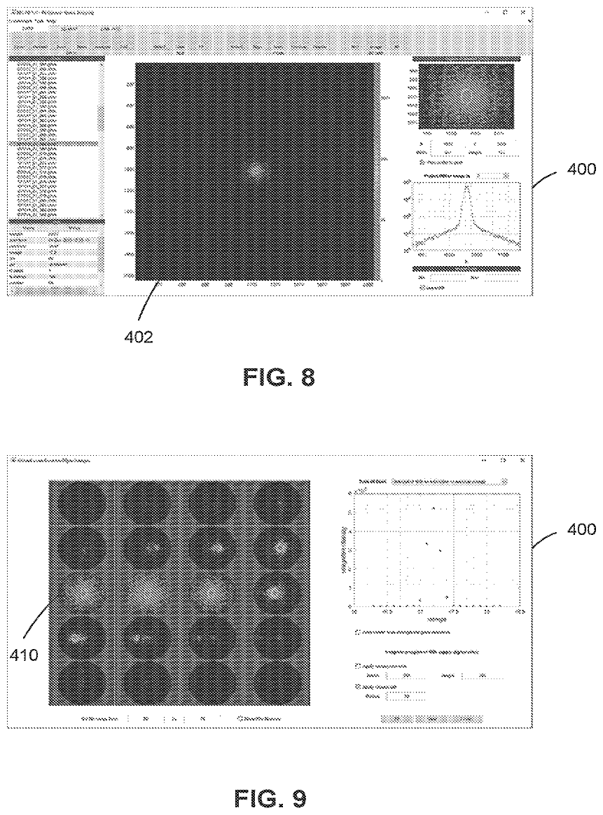

FIG. 8 is an illustration showing a method of directly extracting scans from 2D x-ray images, in accordance with one or more techniques of this disclosure. In one example approach, XRD analysis system 104 allows a user to select a region of interest (ROI) in a 2D image 402 displayed on a display 400 of XRD analysis system 104 (e.g., via a mouse or by entering the parameters of the ROI). In one example approach, XRD analysis system 104 automatically performs imaging analysis, identifying peaks or other features inside the ROI. In one such example approach, XRD analysis system 104 then analyzes a series of images before and after the selected image, determining the range of images to be processed.

In one example approach, XRD analysis system 104 automatically crops the ROIs from the series images that contain the features to be scanned. Depending on the type of the scans, XRD analysis system 104 uses both the position calculation from the virtual diffractometer 108, and peak positions from the imaging analysis, to calculate where to make the image crops. In one example, the ROI of each image of interest is displayed within an array in display 400.

XRD analysis system 104 then performs the integration of the intensities within each crop and makes geometric correction to the integrated intensities. The resulted scan is plotted and may be saved in the project for the subsequent analysis (e.g., comparison, fitting and Fourier transformation).

Unlike all other X-ray diffraction software, in one example approach, XRD analysis system 104 transparently stores analysis results together with the experimental data, allowing future revisiting the results. When XRD analysis system 104 opens an experimental data folder, it creates a project folder underneath. XRD analysis system 104 automatically stores sample information, and 1D, 2D and 3D results generated by the software inside the project folder. When the data folder is re-opened by XRD analysis system 104, those analysis results may be displayed in XRD analysis system 104 for visualization and modification.

For the storage, 3D visualization and processing of wide-range reciprocal space maps (such as the one in FIG. 4), it is impractical to handle the full-resolution 3D data due to the large numbers of pixels involved that cannot be fitted into computer memory. To reduce the processing and storage requirement and make the software practical to run on a PC, while still maintain the same high quality 3D visualization, in one example approach, XRD analysis system 104 uses the following approaches:

Because the peaks and features are very sparse and most area in the images are just uninteresting background, XRD analysis system 104 only stores the full-resolution 3D data around the peaks and non-trivial features. When visualizing the full maps in 2D/3D, the data of many peaks are assembled together.

For wide-range reciprocal space maps that still containing the background information like the one shown in FIG. 4, a single full-resolution map in (H, K, L) is split into three reduced-resolution maps. Each reduced-resolution map maintains full-resolution in two of the three dimensions (H-K plane, H-L plane, and K-L plane, respectively), while reducing the resolution in the third dimension (L, K, H direction, respectively). When viewing the projection or a slice of the 3D data along a certain plane, the (reduced-resolution) map that maintains the full-resolution along the view plane is used. Therefore, such an approach maintains the same visualization quality compared to the full-resolution 3D data, while significantly reducing the storage and processing requirements.

FIG. 9 is an illustration showing a method of simulating slits when directly extracting scans from 2D x-ray images, in accordance with one or more techniques of this disclosure. In one example approach, XRD analysis system 104 offers control of integrated areas within the ROI, to emulate a physical slit on the instruments between the sample and the detector 110 (a physical slit before the detector 110 is difficult to set up since one would need a custom setup for an experiment and, thus, is rarely used, and only for custom-built instruments 102), to reduce the background (i.e., to enhance the signal to noise ratio, when the signal is weak). Since it is software based, it can be precisely optimized for the data analysis (the shape and size) during the data processing, which a physical slit cannot achieve. In one example approach, XRD analysis system 104 offers, for example, rectangular and round shape slits.

In one example approach, a user may use XRD analysis system 104 to extract 1D scans from the constructed 3D reciprocal space maps (i.e., slice 1D data from 3D images), emulating the H, K, L-scan in reciprocal space (like physical H, K, L-scans on synchrotron-based instruments at national labs). In one such example approach, this is achieved by calculating the integrated intensity inside the scan trajectory. One such method is discussed above in the discussion of 3D data construction.

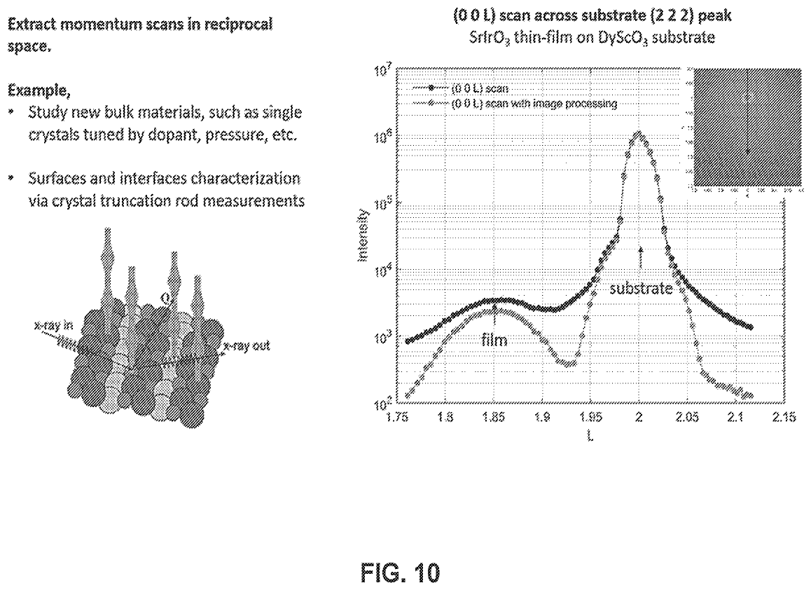

FIG. 10 is an illustration showing a method of extracting momentum scans in reciprocal space, in accordance with one or more techniques of this disclosure. In the example of FIG. 10, image processing is used on the (0 0 L scan to accentuate the difference between the film peak and the substrate peak.

Methods for calculating orientation of the sample being analyzed will be discussed next. In one example approach, XRD analysis system 104 calculates sample orientation both semi-automatically and automatically, therefore greatly simplify the experimental procedure.

For the semi-automatic method, XRD analysis system 104 allows a user to select a peak from an image. In one such example approach, the user clicks near the peak to be used for alignment. The precise position of the peak maximum will then automatically be calculated by imaging analysis algorithm. The imaging analysis will not only find the peak position by analyzing the selected one image, but, in some example approaches, it also performs analysis in a series of images before and after the selected one, finding the image that containing the maximum peak signal and using that strongest peak to determine the most accurate peak position. The user then identifies the Bragg index of the selected peak (e.g., H=1, K=0, L=3) in the image selected by XRD analysis system 104 and XRD analysis system 104 automatically calculates and updates the sample orientation by data fitting.

In the automatic method, which requires at least two prominent, non-colinear Bragg peaks in the image data, XRD analysis system 104 automatically identifies all Bragg peaks in the data. The Bragg peak positions, combined with the instrument angles of the corresponding image files, allows the virtual instrument to calculate the position of those Bragg peaks in reciprocal space (i.e., their Bragg peak indices) for the current inaccurate orientation in the software. Since their theoretical indices are known (this involves XRD analysis system 104 using an algorithm to automatically determine which Bragg peaks the measured peaks are), a 3D rotation matrix may be fitted which corrects the current orientation to make the measured values match theoretical values. This process is fully automatic. In the rare cases such a method fails, the semi-automatic method may be used.

In one example approach, XRD analysis system 104 supports fully automatic analysis and development of automated X-ray diffractometers. First, XRD analysis system 104 scans through all image data from an experiment, using imaging analysis methods above to identify all peaks. Second, XRD analysis system 104 automatically index the prominent Bragg peaks, then use their positions and peak indices to automatically fit sample orientation without manual input. Finally, after the alignment is done, XRD analysis system 104 automatically generates a list of tasks to make 3D reciprocal space maps for the identified peaks, then runs those tasks. Once the tasks are complete (the results are saved in the project folder), users may visualize the results.

In addition, XRD analysis system 104 may be configured with the collaboration of particular instrument 102 builders to enable automated instruments. In one such example approach, XRD analysis system 104 does not control the instrument 102 directly but instead only calculates where to do the measurements. The control of the instruments is then done in the instrument software.

In another such example approach, XRD analysis system 104 may be adapted using the instrument control protocols of particular instruments 102 to directly drive the instruments 102 and to read out the data captured as a series of 2D x-ray images. Using the above-mentioned imaging analysis, XRD analysis system 104 may then automatically do physical scans on the instruments 102, search for the peaks, adjust sample alignment, and automatically generate and run scans (with the constraint provided by the users, for example, in the desired peaks and required resolution in reciprocal space). XRD analysis system 104 may then automatically processes the data, using the results to optimize the subsequent scans. This hardware-software combination forms a closed feedback loop, enabling automated experiments once the instrument 102 and sample have been set up.

In some example approaches, XRD analysis system 104 includes a computing system with memory used to store the project data and the software of the XRD analysis system 104. Some examples of this disclosure relate to a computing system comprising: processing units configured to:
1. interactively and/or automatically determine the positions and width of Bragg peaks and other features in large number of x-ray images;
2. use the peak positions from step 1 to interactively or automatically determine and/or fine tune the sample orientation and the sample unit cell information, including the lattice constant and angles;
3. with the sample orientation and unit cell information determined in 2, extract traditional scans directly from one or multiple x-ray images via computational methods;
4. with the sample orientation and unit cell information determined in 2, convert multiple x-ray images (full images or a crop around Bragg peaks) into a reciprocal space, and assemble the converted x-ray images into a 3-dimensional map in the reciprocal space;
5. with the 3-dimensional map determined from 4, extract H, K, L-scans from the 3D map;
6. perform 1-dimentional peak analysis on scans from step 3 and 5 via interactive or automatic data fitting and Fourier transformation;
7. perform 2 or 3-dimentional data fitting on peaks in 3-dimensional maps from 4;
8. perform 3-dimensional visualize of the 3-dimensional maps from 4; storage units to manage processed data:
9. store peak information from 1;
10. store sample information from 2;
11. store processed x-ray images (the average of multiple x-ray images) for fast visualization;
12. store 3-dimensional maps from 4;
13. store scans from step 3 and 5;
14. store fitting from step 7.
   Furthermore, in some examples, the computing system of XRD analysis system 104 discovers peaks in a large number of x-ray images interactively. In this example, a series of related images are averaged. A user may select the feature of interest from the averaged data, while the processing unit determine the relevant x-ray images for subsequent analysis. In some examples, an imaging analysis algorithm determines all peak position and width from the x-ray images automatically.

In one or more examples, the algorithms, operations and functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

1. A system comprising:
a memory configured to store a plurality of x-ray images captured by a 2-dimensional x-ray detector, each x-ray image in the plurality of x-ray images being a 2-dimensional image corresponding to a different location of the 2-dimensional x-ray detector relative to an x-ray beam that intersects a sample; and
processing circuitry coupled to the memory, the processing circuitry configured to:
determine, based on the x-ray images, orientation of the sample; and
convert the x-ray images into a 3-dimensional reciprocal space image based on the sample orientation.

2. The system of claim 1, wherein the processing circuitry configured to determine orientation of the sample based on the x-ray images is further configured to automatically determine the sample orientation based on detecting a location for each of two or more peaks in one of the x-ray images.

3. The system of claim 1, wherein the processing circuitry configured to determine orientation of the sample based on the x-ray images is further configured to automatically determine the sample orientation based on detecting a location for each of two or more peaks in the x-ray images, wherein detecting includes:
tracking a position of an individual one of the two or more peaks in two or more x-ray images of the plurality of x-ray images to determine which of the two or more x-ray images includes a highest value of the individual peak.

4. The system of claim 1, wherein the processing circuitry configured to determine orientation of the sample based on the x-ray images is further configured to automatically determine the sample orientation based on detection of a location for each of two or more structures in the x-ray images.

5. The system of claim 1, wherein the processing circuitry configured to determine orientation of the sample based on the x-ray images is further configured to interact with a user to identify a location of one or more peaks in the x-ray images.

6. The system of claim 1, wherein the processing circuitry configured to determine orientation of the sample based on the x-ray images is further configured to interact with a user to identify a location of one or more peaks in the x-ray images, wherein identifying includes:
tracking the position of an individual one of the one or more peaks in two or more x-ray images of the plurality of x-ray images to determine which of the two or more x-ray images includes a highest intensity value for the individual peak.

7. The system of claim 1, wherein the processing circuitry configured to determine orientation of the sample based on the x-ray images is further configured to interact with a user to identify a location of one or more structures in the x-ray images.

8. The system of claim 1, wherein the processing circuitry is further configured to extract a 1-dimensional-scan of scattering intensity from the reciprocal space image.

9. The system of claim 1, wherein the processing circuitry is further configured to extract a 1-dimensional-scan of scattering intensity from one or more of the x-ray images.

10. The system of claim 1, wherein the processing circuitry configured to convert the x-ray images into a 3-dimensional reciprocal space image is further configured to:
for each x-ray image of the plurality of x-ray images, for each pixel of the x-ray image, convert the pixel into an array of reciprocal space coordinates and an intensity value;
generate reciprocal space data based on the arrays of reciprocal space coordinates and intensity values; and
rasterize the reciprocal space data into a 3-dimensional grid in the reciprocal space.

11. A method comprising:
determining, based on x-ray images from a 2-dimensional x-ray detector, orientation of a sample, each x-ray image in the plurality of x-ray images being a 2-dimensional image corresponding to a different location of the 2-dimensional x-ray detector relative to an x-ray beam that intersects the sample; and
converting the x-ray images into a 3-dimensional reciprocal space image based on the x-ray images and the sample orientation.

12. The method of claim 11, wherein the method further comprises:
extracting a 1-dimensional-scan of scattering intensity from one or more sources, the sources including the reciprocal space image and the plurality of x-ray images.

13. The method of claim 11, wherein determining orientation of the sample based on the x-ray images includes automatically determining the sample orientation based on detecting a location for each of two or more peaks in one of the x-ray images.

14. The method of claim 11, wherein determining orientation of the sample based on the x-ray images includes automatically determining the sample orientation based on detecting a location for each of two or more peaks in one of the x-ray images.

15. The method of claim 11, wherein determining orientation of a sample includes determining the location of each of one or more Bragg peaks, wherein determining the location of each of one or more Bragg peaks comprises:
for at least one x-ray image of the plurality of x-ray images, identifying features above a background of the x-ray image; and
determining the locations of one or more of the Bragg peaks based on the features above the background of the x-ray image.

16. The method of claim 11, wherein determining orientation of a sample includes determining the location of each of one or more Bragg peaks, wherein determining the location of each of one or more Bragg peaks comprises:
tracking a position of an individual Bragg peak in two or more x-ray images in the plurality of x-ray images to determine which of the two or more x-ray images includes a highest intensity value of the individual Bragg peak; and
determining the position of the individual Bragg peak based on a position of the individual Bragg peak in the determined x-ray image that includes the highest value of the individual Bragg peak.

17. The method of claim 11, wherein converting the x-ray images into the reciprocal space comprises:
for each x-ray image of the plurality of x-ray images, for each pixel of the x-ray image, converting the pixel into an array of reciprocal space coordinates and an intensity value;
generating reciprocal space data based on the arrays of reciprocal space coordinates and intensity values; and
rasterizing the reciprocal space data into a 3-dimensional grid in the reciprocal space.

18. The method of claim 11, wherein determining orientation of a sample includes determining the location of each of one or more Bragg peaks, wherein determining the location of each of one or more Bragg peaks comprises:
selecting a 2D region of interest (ROI) in the plurality of x-ray images;
tracking a position of an individual Bragg peak in the ROI of two or more of the x-ray images to determine which of the two or more x-ray images includes a highest intensity value of the individual Bragg peak; and
determining the position of the individual Bragg peak based on a position of the individual Bragg peak in the determined x-ray image that includes the highest value of the individual Bragg peak.

19. A nontransitory computer readable medium comprising instructions that, when executed by a processing system:
determine, based on x-ray images from a 2-dimensional x-ray detector, orientation of a sample, each x-ray image in the plurality of x-ray images being a 2-dimensional image corresponding to a different location of the 2-dimensional x-ray detector relative to an x-ray beam that intersects the sample; and
convert the x-ray images into a 3-dimensional reciprocal space image based on the x-ray images and the sample orientation.

20. The nontransitory computer readable medium of claim 19, wherein the instructions further comprise instructions that, when executed by a processing system, extract a 1-dimensional-scan of scattering intensity from one or more sources, the sources including the reciprocal space image and the plurality of x-ray images.
